(19) United States
(12) Patent Application Publication
(10) Pub. No.: US 2008/0180537 A1
(43) Pub. Date: Jul. 31, 2008

(54) Camera system and methods

(76) Inventors: Uri Weinberg, Tel-Aviv (IL); Avner Divon, Rosh-Haayin (IL)

Correspondence Address: Avner Divon, 5 Gefen Street, POB 4660, Rosh-Haayin, 48570, omitted

(21) Appl. No.: 11/979,381

(22) Filed: Nov. 2, 2007

Related U.S. Application Data
(60) Provisional application No. 60/858,599, filed on Nov. 14, 2006.

(51) Int. Cl. H04N 5/232; H04N 5/76

(52) U.S. Cl. 348/211.99; 348/231.99; 348/E05.042

(57) ABSTRACT

A system and method for providing visible indications of an area of interest for assisting the visual orientation of a user using a digital camera is provided. The system includes a digital camera having a built in illumination projector. The illumination projector optical axis is related to the camera optical axis. Typically the illumination projector is collimated with the camera. Images produced by the illumination projector are viewed by camera user and are used as a reference for understanding the camera orientation and for selecting the desirable direction and field of view (FOV) for the camera. The system and method is extremely useful for portable and wearable digital cameras as well as for setup of fixed camera applications.

### FIELD OF THE INVENTION

The present invention relates generally to systems and methods of digital camera, visual orientation of digital cameras and digital camera modes of operation.

### BACKGROUND OF THE INVENTION

The following U.S. patents are believed to represent the current state of the art:

| | | | |
|---|---|---|---|
| 7,123,351 | October 2006 | Schaefer | 356/4.07 |
| 6,445,399 | September 2002 | Sroka | 715/767 |

### SUMMARY OF THE PRESENT INVENTION

It is an object of present invention to provide a camera system with a build-in innovative, easy and fast to use, low cost orientation apparatus. It would be appreciated that using a camera system with built in fast orientation means of present invention would enable a user of digital camera to easily and swiftly identify the field of view (FOV) of a camera and be able to promptly point the camera to a direction and FOV of interest.

The camera built in orientation apparatus of present invention consists of an illuminating projector, projecting an illuminating light beam which marks certain areas within FOV of the camera. These illuminating marks provided by camera system of present invention are then viewed by the camera user enabling the user to identify and determine the direction and field of view (FOV) of said camera system and to direct the camera to cover a FOV of interest.

In accordance with the present invention an illuminating orientation apparatus which projects a reference image that is typically collimated with the camera, so a camera user then may move the camera, thus the reference image for selecting a direction and FOV of the camera. A user may continually activate the illuminated reference image so he can continually knows where the camera points. User may select activating the illuminated orientation beam that is used as a reference image just before taking picture, or capturing video. Alternatively user may activate the illuminated reference image while installing a fix camera such as may be the case when the camera is used for security cameras, in-vehicle cameras, or other fix camera installations.

It would be appreciated that camera system with a built in illuminating orientation of present invention, eliminates the need of using an optical view finder such as of traditional cameras, or an expensive LCD display commonly used as a view finder. It would also be appreciated that using illuminating view finder method and system of present invention would enable easy pointing of portable, wearable, mobile and fixed digital camera enabling the user looking at the object to be pictured without the need of looking at the camera through its view finder's means for aiming the camera for covering FOV of interest. It would also be appreciated that using illuminating orientation camera method and system of present invention would enable aiming and pointing said camera system hands-free, such as with head mounted and other wearable or portable camera systems of present invention. It would also be appreciated that using a camera with a built-in illuminating orientation system of current invention enables very fact aiming and shooting pictures or video where fast response is critical such as with wearable camera applications such as sports activities, defense and security, traffic and other fast activities, or while attached to other time critical devices such as when camera is attached to a shooting device.

It would be appreciated that the ease of use of camera with a built-in illuminating orientation system of current invention makes such a camera ideal for digital cameras that may be used by youngsters for fast taking pictures and videos that may later be shared through the Internet or by elder people when ease of orientation understanding is important.

In accordance with a preferred embodiment of present invention, a digital camera with a built-in illuminating orientation system that can record still pictures, video, audio and data such as location and direction related to camera FOV, which is related to said illuminating reference image produced the built-in illuminating orientation system of present invention.

In accordance with a another preferred embodiment of present invention, a digital camera with a built-in illuminating orientation system producing a projected orientation image collimated with direction of camera, the projected orientation image may indicate optical axes of camera, FOV, or FOV related information, zoom, or possibly other camera parameters, or be directed in a different given angular deviation of camera axes.

Further more, projected orientation images of current invention may be concentric or eccentric image shapes, dot, plurality of dots, a line, and plurality of lines, cross lines, straight or curved lines, arrows or other static, symbols. Images may be static or dynamic.

In yet another embodiment of present invention, a camera system with wireless two-way remote control capabilities. said remote control can control said camera operation and also provide indications of camera status and operation. Said indications may be visual, sound or mechanical movements. It would be appreciated that such innovative two-way remote control of a portable or wearable camera would enable hands-free monitoring of camera status and operation during on-the-move operation such as when used in sports activities and especially when camera is not seen by the user such when used as head mounted camera.

In yet another embodiment of present invention, a camera system with wireless remote display capabilities. Said remote display can display said camera pictures and videos online and for replay. It would be appreciated that such innovative wireless remote display of a portable or wearable camera would enable viewing of camera multimedia information while the camera is located remotely from a users eyes such when used in sports activities and especially when camera is not seen by the user such when used as head mounted camera, or when a camera is installed not within comfortable use of a user such as with security cameras. Said remote display can also be used as a remote control device of said camera.

In yet another embodiment of current invention, a camera with event driven capabilities and wherein such events may trigger image, video and audio recording. Further more, said camera of current invention can set for a continues recording mode, where such an event may cause said camera to keep X seconds of information prior to that event and Y seconds of information after that event, so this data will not be erroneously deleted, or overwritten. That protected data then can be replayed or transferred at a later time. Alternatively, Said camera may keep X seconds of information prior to that event and stop recording at user's will.

In yet another embodiment of current invention, a camera with a built-in an optical communication wherein said optical communication is at least used for transferring images related data from said camera to a remote location. Further more said optical link can be directed to an arbitrary direction to that of the FOV of the camera. In addition another preferred embodiment of present invention is a two way optical link to also transfer comments to camera.

### BRIEF DESCRIPTION OF THE DRAWINGS

The present invention will be understood and appreciated more fully from the following detailed description, taken in conjunction with the drawings in which:

FIG. 1 is a simplified partially pictorial functional block diagram, illustrating a preferred embodiment of the present invention, including a camera system with a built in illuminating orientation projector.

FIG. 3 is a simplified functional block diagram, illustrating various implementations of the functionality of FIG. 1.

FIG. 5: FIGS. 5A, 5B, 5C, 5D, 5E, 5F, 5G, 5H, are various pictorial illustrations of possible preferred marking of illuminating orientation patterns of the present invention.

FIG. 7: are various pictorial illustrations of possible preferred implementations, installations and use of the present invention. FIG. 7A illustrates a sample of a wearable camera system with a built in illuminating orientation of the present invention, FIG. 7B illustrates a sample of portable implementation and use and FIG. 7C illustrates a sample of fixed installation implementation and use of camera system with a built in illuminating orientation of the present invention.

FIG. 9: FIGS. 9A, 9B, 9C, 9D are various pictorial illustrations of possible preferred implementations of activation buttons of the present invention.

FIG. 11 is a simplified partially pictorial functional block diagram illustrating a preferred embodiment of various optics of orientation illumination of the present invention.

FIG. 13, is a simplified flow-chart illustrating operation, activations and functionality of a preferred embodiment of the present invention.

FIG. 15, is a simplified state and flow diagram illustrating operation and functionality of a preferred embodiment of the present invention.

FIG. 17A is an illustration of a camera memory management prior art. FIG. 17B is a simplified illustration of camera data memory management and functionality of yet another preferred embodiment of the present invention.

FIG. 19A is a simplified illustration of a camera with an optical link of yet another preferred embodiment of the present invention. FIG. 19B is a simplified functional block diagram related to FIG. 19A. 19C is a simplified illustration of a camera with an optical remote sound detector of yet another preferred embodiment of the present invention.

FIG. 21A is a simplified functional block diagram, illustrating another preferred embodiment of the present invention, including a camera system with a wireless remote display. FIG. 21B is a simplified partially pictorial functional block diagram, illustrating once possible implementation of the functionality of FIG. 21A.

### DETAILED DESCRIPTION OF PREFERRED EMBODIMENTS

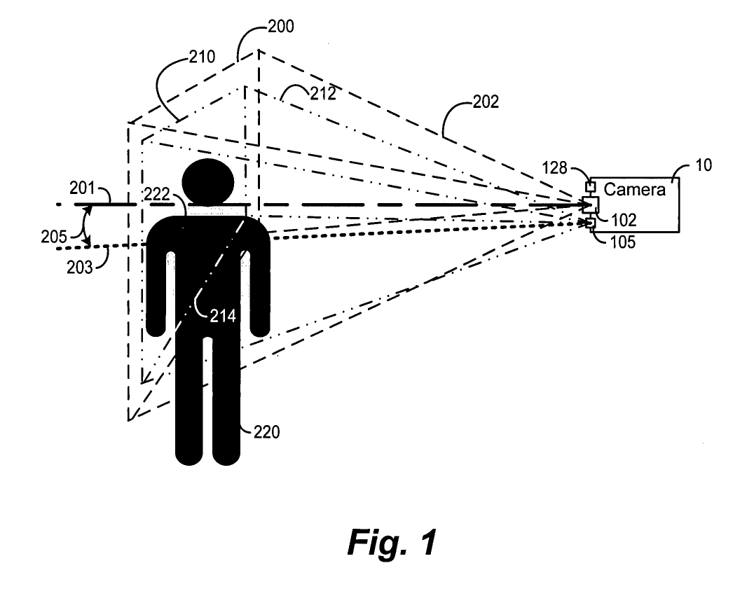

Reference is now made to FIG. 1 which illustrates a camera system with a built-in orientation apparatus of a preferred embodiment of present invention and its general operation.

In accordance with a preferred embodiment of present invention, camera system 10 comprises an optical image sensor 102 with field of view (FOV) 200 that is similar to the FOV of the camera system 10. In accordance with a preferred embodiment of the present invention, a camera system 10 also comprises of a light illumination assembly 105. The light illumination assembly 105 produces a light beam which provides a light marking 210 on a background surface. If an object 220 resides within light marking area 210, a light marking 214 will also be reflected form object's part 222 that is within the marking area 210. Said light marking will be viewed by the user of camera 10 and will be used by user for perceiving camera 10 orientations.

A preferred embodiment of present invention, an optical axis 201 of optical image sensor 102 of camera system 10 is collimated with optical axis 203 of light illumination means 105. In accordance with a preferred embodiment of current invention camera system 10 is a digital camera system that may be small, light weight and preferably portable, stand alone, attached to, or embedded within another apparatus.

In another preferred embodiment of present invention an optical axis 201 of optical image sensor 102 of camera system 10 may set to be at an angular diversion 205 with respect to optical axis 203 of light illumination means 105.

It would be appreciated that current invention enables a user of camera system of present invention, to keep his eyes on area of interest 200 for aiming camera system 10 and for taking pictures, or recording videos. By watching the projected illuminating orientation image 210, 214, user comprehends camera orientation without a need to watch through an optical viewfinder (such as the case with classic cameras), and without the need of watching a LCD display. These capacities enable using camera system with built-in orientation capabilities of present invention for portable or wearable camera applications such as action and sports activities. Due to the immediate understanding of camera orientation unique capabilities of camera system of present invention, it can be used for applications and situations where immediate camera orientation is required. Such applications may be by connecting or embedding camera systems of present invention with shooting apparatuses. The ease of use of camera system with a built-in orientation functionality of present invention makes such a camera system ideal for digital cameras that may be used by youngsters for fast taking pictures and recording videos using “point and shoot” or the innovative “look and shoot” method such as while using head mounted camera of present invention. These multimedia recordings may later be transferred to other computing or storage devices, or to be shared through the Internet. It can also be used by elder people when ease of orientation understanding is important.

In accordance with a preferred embodiment of present invention, a digital camera with a built-in orientation system 10 that can record and store multimedia data in plurality of formats such as: still pictures, video, pictures and audio, video and audio of camera FOV 200 which is related to a reference image 210, 214 produced a built-in orientation system 105. Said multimedia data may also include time and date, location, pointing direction, velocities, accelerations, temperature, humidity and other physical parameters that are related to location, operation and environment of said camera.

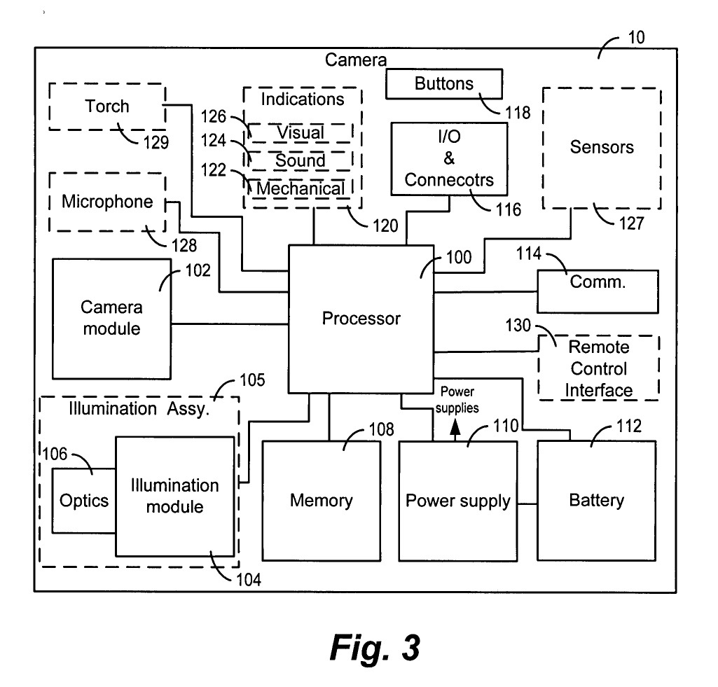

Reference is now made to FIG. 3, a functional block diagrams illustrating few possible preferred implementations of a digital Camera system with a built-in orientation 10 of present invention. A Camera system 10 comprises of a camera module 102. A camera module 102 of a preferred embodiment of present invention is based on digital image sensor such as CCD, CMOS or other image sensors. A camera module 102 may also consist of optical system that may include lenses, zooming means, image stabilization apparatus, auto focus means, filtering means. A digital processor 100 typically communicates with image sensor of camera module 102, receives image raw data, or pre-processed image data then may preferably performs additional image or video processing. Such image or video processing may include image compression such as JPEG compression for pictures, video compression such as motion JPEG, MPEG-1, MPEG-2, MPEG-4, H.264, or other compressions. Video processing may also include additional image and video processing such as: video motion stabilization algorithms, video motion detection (VMD), pattern or objects recognition, video tracking, video alerts, video tagging, filtering, stitching, and others possible algorithms. The digital processor 100 may also manage other functionalities of camera system 10. Such functionalities include managing the application, controlling of camera module 102, managing memory 108, receiving user commands from buttons 118, from communication 114, or from a possible remote control interface 130, managing communication 114 with external devices. Such communication 114 may be wired communication such as RS232, USB, Ethernet, I2C, SPI, and possibly others, it may also be a wireless communication such as RF communication that may be Wi-Fi, WiMax, Bluetooth, UWB, Zigbee, proprietary RF, cellular or other RF communications, or it may also be an optical link. Communication 114 may be used for online or off-line digital data and multimedia data transfer from and to camera system 10, Communication 114 may also used for transferring program, parameters and or passing commands and status to and from camera system 10.

Digital processor 100 may also responsible for providing indications to the user 120. Such indications may include visual indication 126, possibly using: LEDs, LCD, or other visual means; sound indications 124, possibly using: a speaker, buzzer, or other sound means; mechanical indications 122 such as vibration. Digital processor 100 may also be connected to a power management and supply 110, and may monitor power supply and battery status and operation.

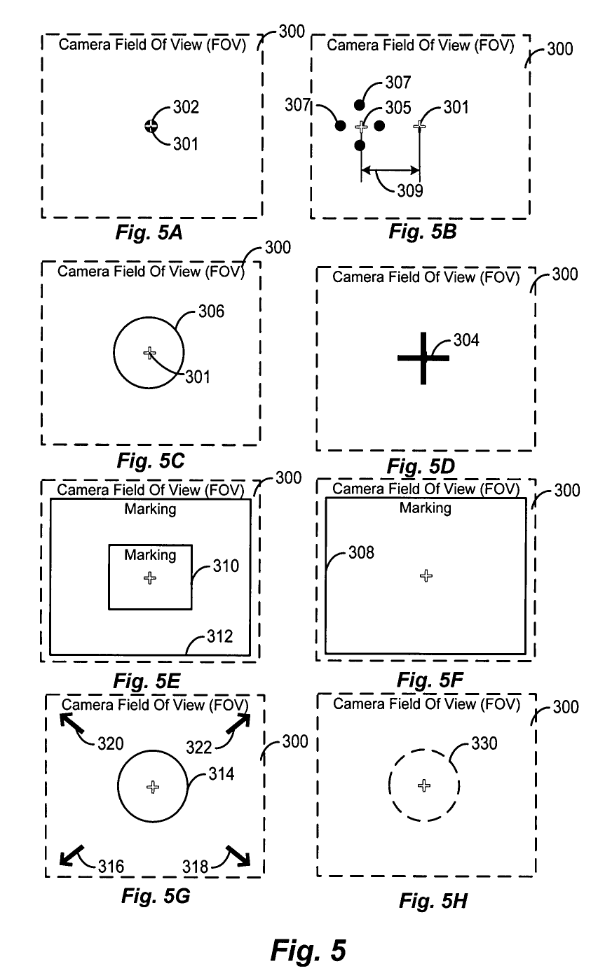

Digital processor 100 may also be responsible for activation of illumination assembly 105. The illumination assembly is used for providing an illumination beam that is used by a user for comprehending the orientation of camera system 10 of present invention. The illumination assembly 105 may consist of illumination module 104 which produces light illumination. In a preferred embodiment of present invention an illumination module 104 is a laser module. Alternatively illumination module 104 may also be a LED, supper bright LED or other bright light sources. Illumination assembly 105 may also include Optics 106. Optics 106 may be a hole, pinhole, a mask, a lens, plurality of lenses, film and possible other optical means. The illumination assembly 105 produces light shapes such as 102 of FIG. 1 and such as those illustrated in FIGS. 5A,5B,5C,5D,5E,5F,5G that may be used for orientation marketing of camera system 10

In yet another prefer embodiment of present invention, an illuminating assembly 105 that is used for illuminating orientation, which may be activated from buttons of 118 of camera system 10; according to application commands of Processor 100; according to sensors 127 status, communication 114, or according to remote control 130 commands. Sensors 127 may be one or more of the followings: optical sensor (such as light or IR detector); mechanical motion sensor such as accelerometers, gyroscopes, tilt sensors, and similar mechanical motion sensors; Global Position System (GPS) receiver; environmental conditions sensors such as: humidity and wet sensors, temperature sensors, gas sensors, conductive, inductive or capacitive sensors and other physical parameters sensors. The sensors data may also be recorded as meta-data onto Memory 108 along with recorded multimedia data (e.g. video, images, sound, and data) and other meta-data such as time and date, user related information, etc.

It is yet another embodiment of present invention that some of the abovementioned processing algorithms of digital processor 100 will alternatively be performed by yet another processor, a system on chip (SOC), or a by dedicated hardware such as ASIC, or a combination of such chips.

A microphone 128 may be used for acquiring audio signals and converting them into electrical audio signals that are then converted to digital audio signals and then may be processed within the digital processor 100, typically processor 100 compresses these signals and may mix them with image, or video signals to be stored within multimedia data.

Memory 108 may be used for program memory; variables and data memory. Data memory may include application data, multimedia data of: images, video, audio, time, tagging, and possibly other data types. Memory 108 typically consists of both volatile and nonvolatile memory such as: RAM and Flash and it may resides within digital processor 100, or be external to processor 100, or have part of it within processor 100 and rest externally to processor 100. Memory 108 may also include a hard disk. Memory 108 may also include a removable memory such as Flash card that may be SD, Micro SD, MMC, Memory stick and other types of detachable Flash memory, or other non-volatile memory.

Power of camera system 10 is preferably provided by a battery 112 which may preferably be a rechargeable battery. A power management and supply 110, manages power of camera system 10. It typically provides all stabilized voltages that are needed by camera system 10 components, manages battery charging and status, provide reset and other functionalities. An external power source may be connected through connectors 116 and used for operating the camera system 10, and or for charging battery 112.

Input/Output (I/O) and connectors 116 may consist of discrete connections for receiving signals and activations and for outputting signals and activations to external systems and devices. Such I/O may be digital, analog, optical, RF, Open Collector, or dry contacts such as a replay.

It is yet another embodiment of present invention a camera system 10 may include sensors such as motion sensors, sound sensors, light and IR sensors such as a PIR, temperature sensors, location sensors such GPS, motion sensors may also include Inertial unit (INS), accelerometers, magnetic sensors and possibly others. These sensors' data may be used by processors 100 for activating camera unit 10, trigger a recording, or a data transmission process, tagging data, or for changing camera unit 10 mode of operation.

It is yet another embodiment of present invention that camera system 10 includes a light source that may be used as a torch, or as a pointer.

It is yet another embodiment of present invention a camera system 10 that may record multimedia data such as: images, video, audio and data information onto its memory upon a user command. A command may be received from buttons 118, from I/O 116, via communication 114, or as a result of sensors measurements, or by passing a sensor threshold, or due to video processing detection, such as VMD. Data types to be recorded upon activation may be set by a camera user. These data types may also be transferred in real time and or offline through communication 114. The stored multimedia data may be transported externally also by removing a removable memory such as flash card.

It is yet another embodiment of present invention that camera system 10 has a pre-event recording mode of operation: in which said camera continuously records images, video, audio and data information onto its memory. Upon receiving an “event” command, camera 10 will hold and store said data types from X second prior to said “event” command and keep recording for additional Y seconds. That data will be marked and will not be erased by new recordings. It will be appreciated that this capability enables memorizing visual happenings prior to an event. Such event may be a user command, a sensor status, or an external event or command. This capability may be used for example for video recordings traffic violation. While camera system 10 points at the road ahead of a car, upon detecting a traffic violation, activating an “event” command would enable memorizing video of X seconds prior to said event detection and Y seconds after that event, providing replay capabilities of the whole sequence of events prior and after the “store” command. It would be appreciated that prior and after event recordings provide powerful means for reconstructing and replying events which occur without a prior notice.

Reference is now made to FIG. 5, which shows some of many possible image shapes 5A,5B,5C,5D,5E,5F,5G., which are related to orientation illuminating beam paterns that are used for possible reference marking image 210 of FIG. 1. By looking at the orientation illuminating marking image 210 of FIG. 1 a user of camera system 10 comprehends camera system 10 orientation. Consequently user may move camera system 10 accordingly in order to aim and capture areas of interest such as FOV 200 of FIG. 1. FIG. 5A shows one alternative of a preferred reference light marking shape of present invention, field of view (FOV) 300 of camera 10 and a dot 302 of light or a plurality of dots are being used as a reference light marking. Preferably the axis of reference light marking 302 is collimated with optical axis (center) 301 of FOV 300 of camera system 10. FIG. 5B shows an alternative of another preferred reference light marking of present invention, field of view (FOV) 300 of camera 10, a plurality of dots 307 of light are used as a reference light marking with an axis center at 305. The axis of reference light marking 305 may be diverted 309 from optical axis (center) 301 of FOV 300 of camera system 10. FIG. 5C shows yet another alternative of a preferred reference light marking of present invention, an illumination shape marks an area 306 using a curved line, plurality of lines or plurality of straight lines within FOV 300 of camera system 10. Center of reference mark 301 may be collimated with axis of FOV 300, or may be diverted 309 from optical axis (center) 301 of FOV 300 of camera system 10. by a given angle. FIG. 5D illustrates yet another alternative of a preferred reference light marking of present invention; a symbol is used as a reference light, marking area of interest of camera system 10. Illuminating marking symbol shape 304 may be a cross, which also help for user's comprehending of said camera X-Y axes orientation, or any other symbol. FIG. 5E shows yet another alternative of a preferred reference light marking of present invention, plurality of marked areas are used as reference illuminating marking of area of interest of camera system 10. As an example FIG. 5E shows plurality (e.g. 2) concentric rectangular of illuminating marking within FOV 300. FIG. 5F shows yet another alternative of a preferred reference light marking of present invention, illuminating an area that is similar to FOV as reference for area of interest of camera system 10. It may be rectangular, curved, or have other shape of illuminating lines. FIG. 5G shows yet another one of many possible alternatives of a preferred reference illuminating marking of present invention: plurality of symbols, lines and marked areas are used as reference illuminating marking of area of interest of camera system 10. FIG. 5G shows yet another alternative of a preferred reference light marking of present invention, symbols, illuminating lines and area marking may have dynamic movement used as dynamic illuminating reference marking of area of points and areas interest of camera system 10. All reference light marking centers 305 may be collimated with center axis 301 of camera FOV 300, or set with a static of dynamic angular diversion. It will be appreciated that illuminating marking shapes of present invention are not limited by what has been particularly shown and described hereinabove.

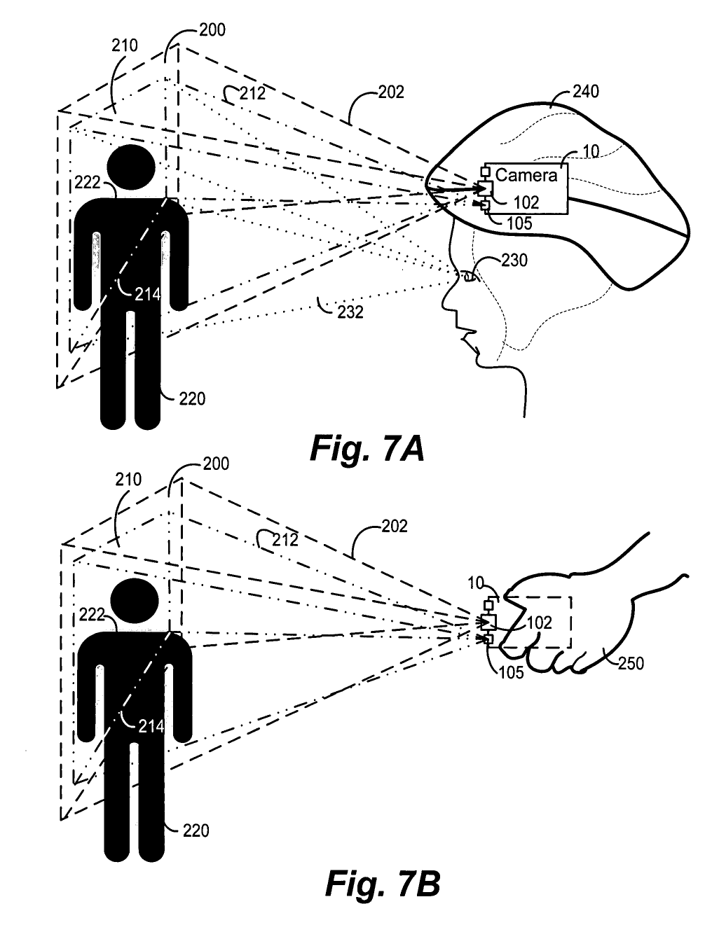

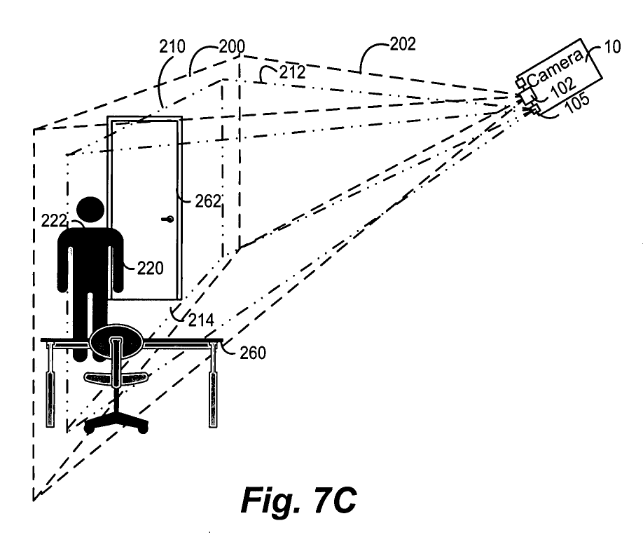

Reference is now made to FIGS. 7A, 7B, 7C which show illustrations of typical use and applications of preferred embodiments of present invention. A camera system 10 is used for wearable applications is shown in FIG. 7A. Camera system 10 is attached to helmet 240, image camera 102 covers FOV 200, an orientation illumination 105 projects illuminating beam 212 that creates illuminating marks 210, 214 on backgrounds and object of interest 222. User's eyes 230 observe illuminating marks 210, 214 and use it is a reference for understanding camera system 10 orientations. User may move his head accordingly for better pointing orientation illumination 105 on object of interest 222 thus better pointing camera system 10 FOV 200 on object of interest 222. It is yet another embodiment of present invention that camera system 10 can be connected to belts, or bands be attached to other parts of the body, clothing, wearable devices, be embedded within wearable clothing or apparatuses that are wear or carried by users, such as sports apparatuses, shooting devices, fishing devices, attached to another apparatus such as bicycle handlebars and more.

A camera system 10 is used with portable sports, defense, portable and mobile applications such as handheld application that is shown in FIG. 7B. Camera system 10 is held by hand 250 of a user. Camera system 10 can be held or connected to other parts of user's devices, such as with a headband. A Camera system 10 can be attached to animals, or apparatuses. It would be appreciated that Camera system 10 of present invention can be embedded with other devices, or used as a stand alone camera system, it may also be used for mobile and vehicles applications such as cars, bikes, motorcycles, flying apparatuses, parachutes, gliders, tracks, trains, or other vehicles. It can be attached or integrated with weapons such as a pistol, a riffle, a bow. Camera system 10 can be used in and under water, or for flying applications. Camera system 10 may also be used for toys, learning aids, entertainment and other consumer application. Camera system 10 of present invention may be also used as part of augmented display applications and apparatuses, such as with connection to Head Up Displays (HUD), or a Remote Display and, or with regards to wireless connectivity of camera system 10 to wireless networks such as such as Wi-Fi, WiMax, Bluetooth, UWB, Cellular or others.

Referring now to of FIG. 7C, yet another embodiment of present invention, a camera system 10 installed as a fixed camera. Such installations may take place within buildings, vehicles and other fixed installations. Orientation illumination 105 projects an illuminating beam 212 that create illuminating marks 210, 214 on backgrounds and object of interest 222 so a user can easily view camera system orientation while installation of the camera and easily adjust and tune the camera positioning according to required FOV 200 for appropriate optical coverage by camera system 10. It would be appreciated that Orientation illumination 105 of camera system 10 enables user to comprehend the FOV coverage of camera system 10, consequently it enables easy installation of camera system 10 for security camera applications and consumer camera applications such as baby monitoring camera, or vehicle mounted applications.

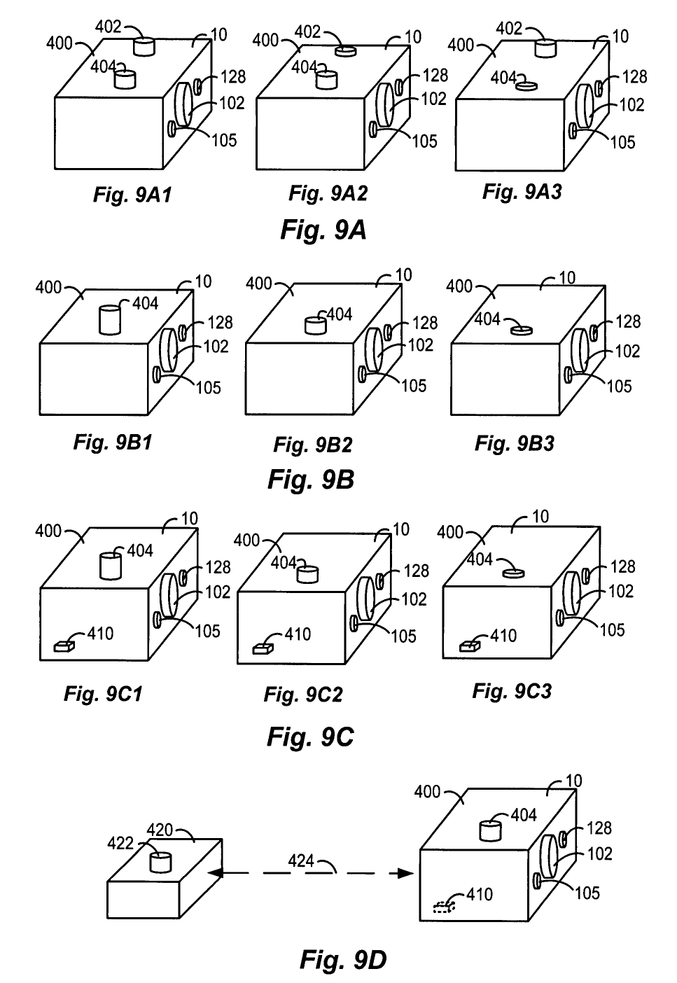

Reference is now made to FIGS. 9A, 9B, 9C, 9D, 9E that show some possible alternatives of activation buttons of camera system 10 of present invention; FIG. 9A1 shows a camera system 10 having a case 400, Image camera 102, Illuminating assembly 105 and possibly also a microphone 128 and has two activation buttons: An illumination marking activation button 402 and a camera activation button 404. FIG. 9A2 shows pressing the illumination marking activation button 404, which activate marking illuminator 105. FIG. 9A3 illustrates pressing activation button 402 activates camera. FIG. 9B shows yet another alternative of activating camera system 10 of present invention, using the same button 404 for activating illuminating marking projector 105 and for activation camera 102. FIG. 9B2 illustrates a partial press of activation button 404 that consequently activates marking illuminator 105; FIG. 9B3 illustrates a full press of activation button 404 which consequently deactivates marking illuminator 105 and activates camera 102. In yet another alternative implementation of single button activation of illumination and Camera of present invention, pressing button 404 activates illumination for X seconds, than automatically turns illumination OFF and activates camera 10 in a sequential sequence.

FIG. 9C illustrates a special button for enabling/disabling marking illuminator function 410. FIG. 9D shows yet another preferred embodiment of present invention, a remote controller 420 and a camera system 10 that can be remotely controlled. Activating button 422 of remote controller 420 sends activation commands to camera system 10 of present invention.

FIG. 9D illustrates a remote controller 420 may be used with camera 10. The link between the remote controller 420 and camera 10 may be implemented using a wired link 424, or preferably a wireless link 424 for passing the commands and preferably also receiving status data from camera 10. Such a wireless link may be RF such as Bluetooth, Zigbee, or other RF protocols. Alternatively the link 424 may also be an optical link such as IrDA or other optical protocols, or a sound link. The link 424 may implement as a one way protocol for passing commands from the remote controller 420 to the camera system 10, or a two-way link 424 which also enables passing acknowledge, status and data back from camera system 10 to the remote controller 420. Remote controller 420 may also be capable of controlling marking illuminator 105 and camera 102 functionalities of camera system 10. A Remote Controller 420 is capable of providing camera system 10 indications such as: Video Recording is ‘ON’, Picture is captured, ‘Battery Low’, ‘Low memory’, Recoding stopped, and other data. These indications can be visual such as light or image indications, sound, or mechanical indications such as vibrations that are generated by a controlled moving mass (i.e. vibrator).

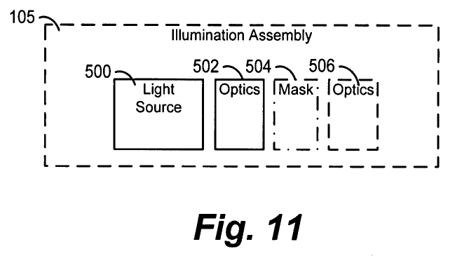

Reference is now made to FIG. 11, a functional schematics illustrating one of possible preferred implementations of a illumination assembly 105. A light illumination assembly 105 consists of a light source 500 and optics 502 such as a lens or a plurality of lenses. Alternatively or and in addition it may also include a mask 504. A mask may be used for creating a desired marking shapes and patterns such as illustrated in FIG. 5. Such a mask may be a shaped hole, or a film, or a diffractive optic element (DOE) or a holographic optical element (HOE). In addition it may also include additional optics 506 such as a lens. The Light source 500 should have high enough intensity to be seen in a distance of few meters while being reflected from objects. A Light source 500 may be implemented using a LED, Supper bright LED, or preferably a laser; alternatively it can be implemented by other high illumination light source. A Light source 500 may illuminate with a visible wavelength, or invisible wavelength such as IR. Using invisible to a bare human eye wavelength may be used when confidentiality is required such as with security related applications. In such cases, a user should have means for observing said wavelengths. A Light source 500 may be controlled by processor 100 of camera system 10, or be directly controlled by camera systems buttons 118 of FIG. 3.

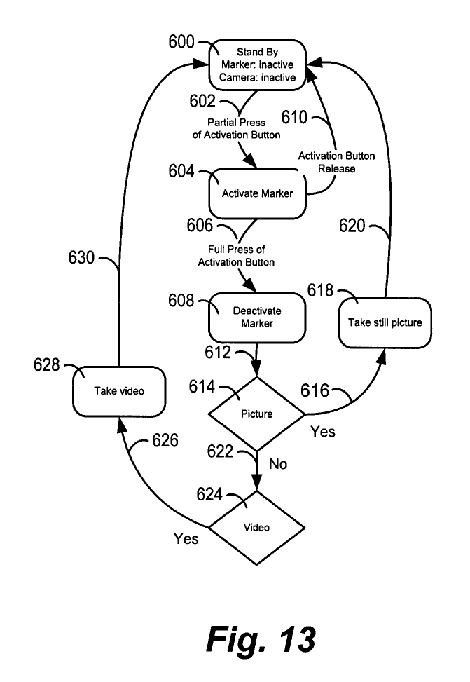

Reference is now made to FIG. 13, a functional states and flow diagram which illustrates a camera with video and picture recording capabilities and where camera activation and marking illuminator activation are activated by same button, which are one possible preferred embodiment of present invention. While Camera system 10 is at its stand by state 600, both image camera and marking illuminator are inactive. A partial press of Camera activation button 602 activates marking illuminator 604. If Camera activation button is released 610, camera system returns to its stand by state 600 where both image camera and marking illuminator are inactive. Alternatively, if Camera activation button is fully pressed 606, then marking illuminator becomes inactive 608 and moves 612 to activate image camera according to camera mode of operation. If camera system is at a picture mode 614, then camera system captures a still picture 618 and moves back 620 to its stand by state 600. If camera system is at a video mode 624, camera system captures video 628 as long as user activates the video recording function. Once video recording is stopped, Camera moves back 630 to a stand by state 600.

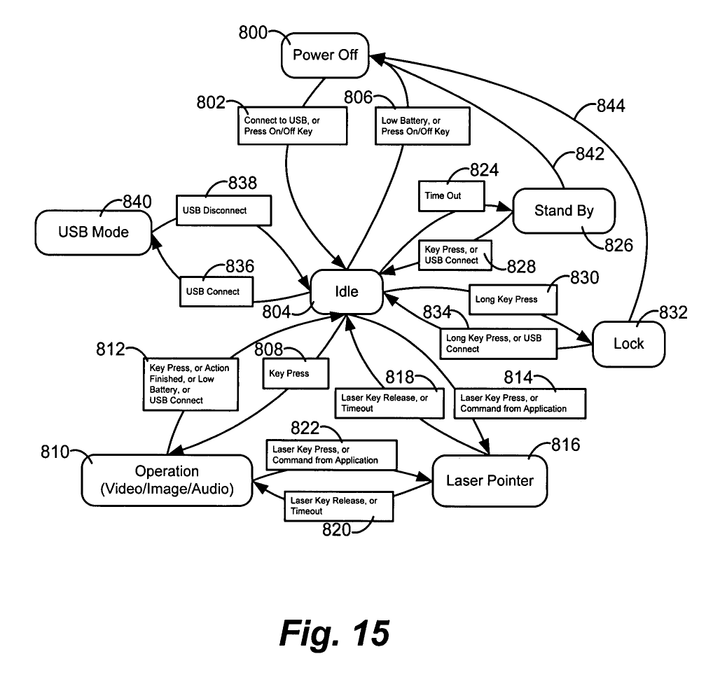

Reference is now made to FIG. 15, a functional states and flow diagram which illustrates yet another possible preferred embodiment of present invention. On Power Off state 800, camera system 10 is inactive and is not powered. Powering up Camera system 10 is done by pressing the ON/OFF button, or by connecting the USB cable 802. Once powered up, the system is at Idle state 804. By pressing one of the activation buttons 808, Camera will move to an Operation state 810. In Operation state camera 10 will capture and store images, video, audio according camera mode of operation and activation button type. Camera will return to Idle state 804 in case of one of the followings: action is finished, a key released, a Battery is low, or if USB is connected 812. when camera is at Idle state 804 marking illuminator is activated 816 upon pressing a laser button, or partial pressing of camera activation button (in case such a button mode is implemented), or by a command from application 814. Returning to Idle state 804 from laser pointer state 816 occurs upon timeout, or Laser key is released 818. Moving from Operation state 810 to Laser pointer state is done if Laser button is pressed, or due a command from application 822. Moving from Laser Pointer state to Operation state 810 is done when Laser key is released, timeout, or camera activation key is fully pressed 820.

Moving to a Lock state 832 from Idle state 804 may be done by a long key press 830, or by pressing a combination of keys 830. Returning to Idle state 804 may be done by a long key press 830, by pressing a combination of keys, or by connecting the USB 834. Moving from Idle state 804 to Stand by 826 may be done by timeout 824; Returning to Idle state 804 may be done by pressing a key, or by connecting the USB 824. Moving from Idle state 804 to USB state 840 is done by connecting the USB 836. Returning to Idle state 804 is done by disconnecting the USB 834.

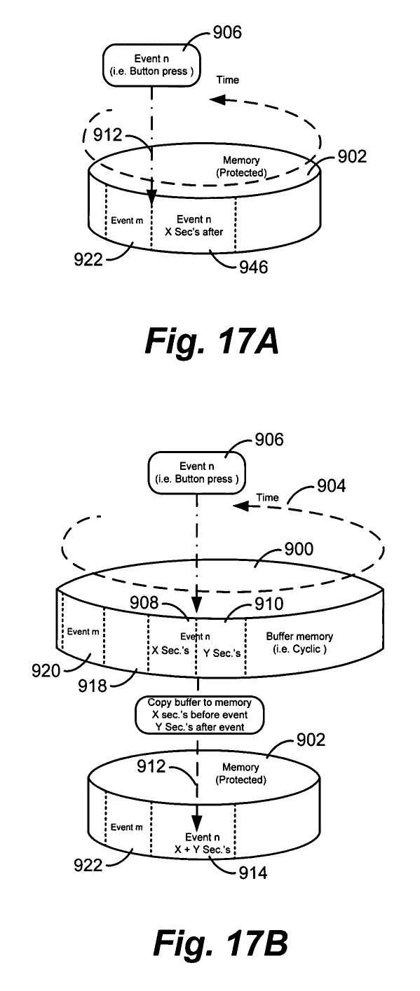

Reference is now made to FIG. 17A, illustrating a prior art of a camera system memory management for capturing and storing video events. On an event 906 which may be a press of a button, a command from an application, or a sensor driven event, the camera starts capturing video and record it onto memory area 946 of data memory 902. Memory area 946 of that will contain data of event 906 from the moment of the event occurrence and on. It will be indexed with said event.

Reference is now made to FIG. 17B, camera system memory management for capturing and storing video prior and possibly also after an event of yet another preferred embodiment of present invention. On activation of video recording of a Camera system, video is captured and stored onto a Buffer memory 900. Typically video is being continuously stored in a cyclical order 904 within Buffer memory 900. On an event 906 which may be a press of a button, a command from an application, or a sensor driven event, a memory buffer that is equivalent to X seconds 908 before occurring of event 906 and possible also a memory buffer that is equivalent to Y seconds after event 906 are copied 912 to another memory area 902 onto a memory section 914 that is protected from being overwritten. Alternatively, the buffer memory of X seconds 908 before occurring of event 906 and possible also a memory buffer that is equivalent to Y seconds after event 906 are marked as protected (and without being copied to another location). Yet another preferred alternative is that on an event 906, a memory buffer that is equivalent to X seconds 908 before occurring of event 906 is copied 912 to another memory area 902 onto a memory section 914 that is protected from being overwritten. Video data will be recorded also after the event onto memory section 914 of protected memory area 902 till another event occurs (such as a release of a button, a second press of a button, or an application command). It would be appreciated that this and similar memory management methods enable camera system users to have a record of video prior to an event and consequently be able to replay events from a time before and possibly after the occurrence of that event. Such method is highly valuable in many situation that where visual information prior to an event are important. For example a Camera of present invention may be installed within a vehicle. Said memory management method enables a driver to press a button when he sees a traffic violation and all visual information prior and after that event are being stored and protected, so user may replay it at any given time. Similarly, when camera system of present invention is being used in conjunction with a rifle, a video of before and after a shot can be stored and replayed. It can be seen that events are stored adjacently to each other and in an efficient manner so an event m 922 and event n 914 in protected memory 902 may be stored adjacently, even though event m 920 may occur with time difference 918 before event n 906.

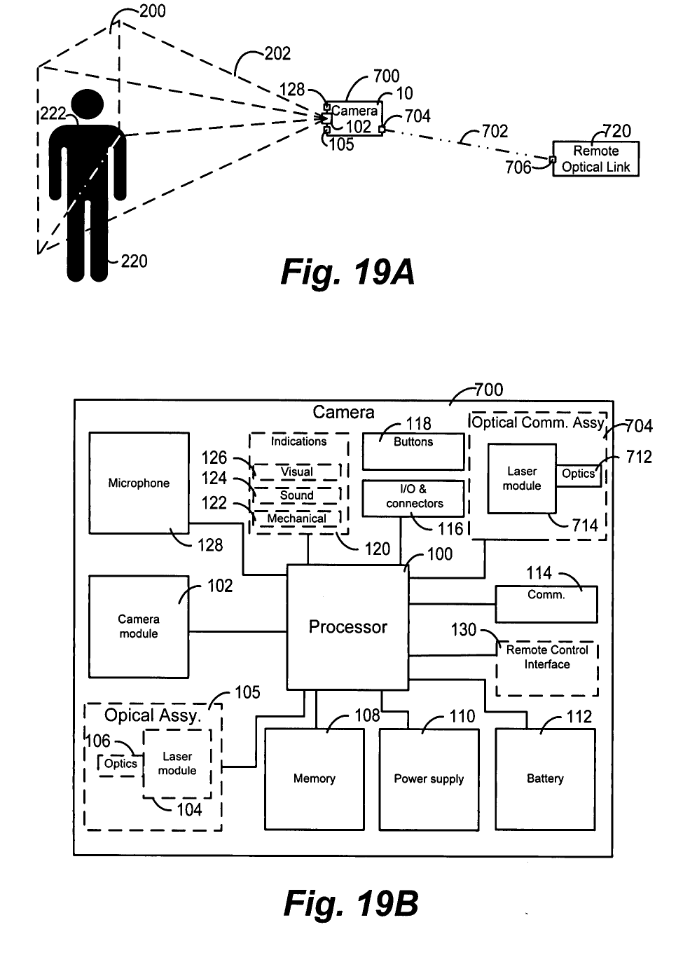

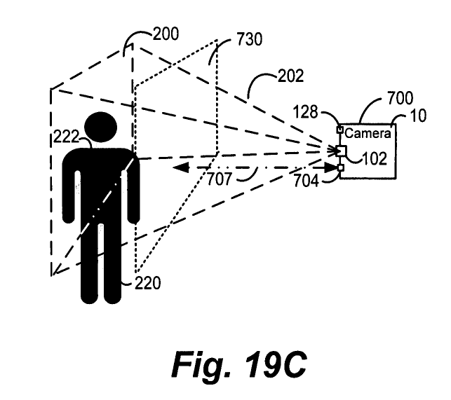

Reference is now made to FIGS. 19A, 19B. FIG. 19A illustrates a camera with a built-in optical communication system of yet another preferred embodiment of the present invention and its general operation. Camera 700 records any mix of the following formats: pictures, video, audio of FOV 200 of image sensor camera 102. A built in optical communication unit 704 of camera system 700 transmits data of camera system 700 over an optical link 702. A Remote Optical Communication unit 720 of an Optical link 702 receives said data. Said data may be pictures, video, audio and status data of camera 700. Optical communication unit 704 and remote optical communication unit 720 may utilize a unidirectional, or a bidirectional communication protocol. FIG. 19B is a block diagram of a camera system 700 with Optical communication assembly 704 provides an optical communication. Optical communication assembly 704 preferably consists of an illumination module 714 and optics 712. Illumination module 714 is a preferably high light illumination source such as a laser or super bright LED for optical transmission. It may also include a light sensitive sensor and receiver for receiving light communication if a bidirectional optical communication is implemented. Processor 100 communicates with illumination module 714 sends it data to be transmitted and possibly also receives data from illumination module 714. It would be appreciated that using built in optical communication with a camera system of present invention may be very important for many applications such as security camera applications and where RF link would not be best solution. Another yet preferable embodiment of current invention, the line of sight of optical link 702 and line of sight of camera 700 may be set by user to an arbitrary angular difference. Reference is now made to FIGS. 19B, 19C. It is yet another preferred embodiment of the present invention and its general operation. Camera 700 records any mix of the following formats: pictures, video, audio of FOV 200 of image sensor camera 102. A built in optical communication unit 704 of camera system 700 transmits a light beam 707 such as a laser beam towards a target 222 within FOV 200 of said camera system 700 from an optical link 702. When said light beam hits object 730, such as a window, located near target 222 which may be a human, the light beam is modulated by that object's movements. These objects movements may be as a result of the sound generated by target 222. The reflected and modulated light beam 707 is received by optical communication unit 704 which decodes the modulated reflected light and convert it to audio digital signals that are then processed by processor 100. These audio signals are then mixed with the images and video of camera 102 and stored within memory 108 and possibly also provided to external use as analog audio signals through sound interface 124 of camera system 700. The multimedia information can also be transferred out through communication interface 114.

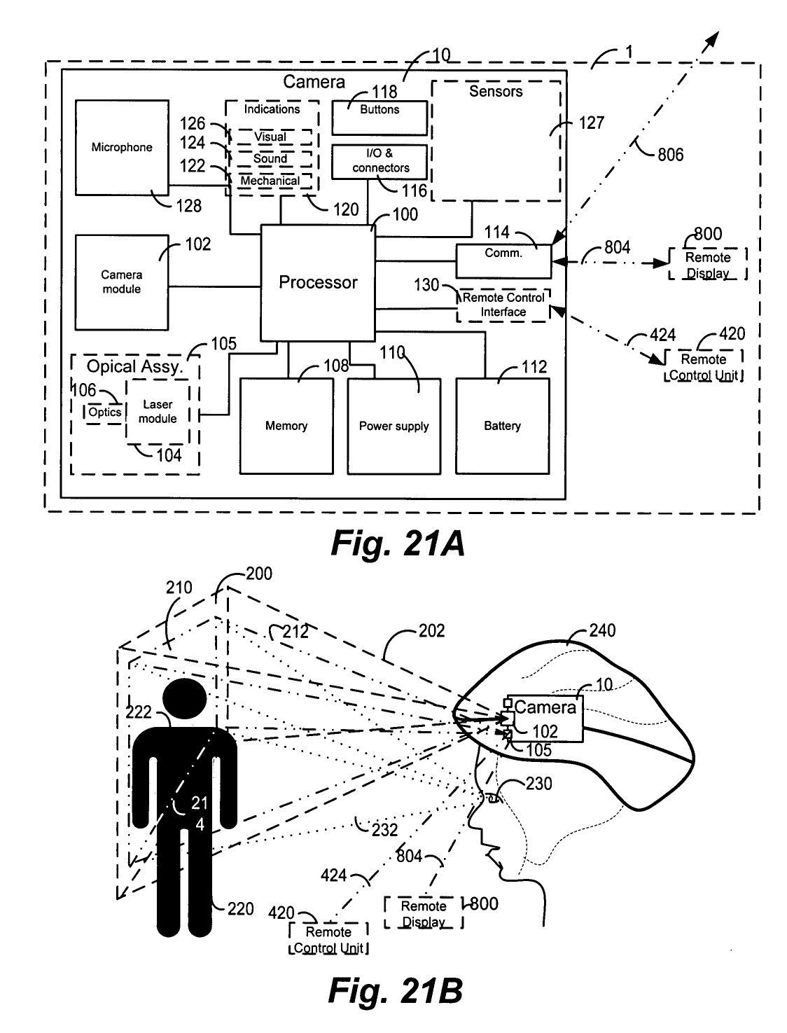

Reference is now made to FIGS. 21A and 21B. FIG. 21A, a functional block diagram further explaining a preferable implementation of a digital Camera 10 of present invention. A Camera system 1 comprises of a digital Camera system 10 and possibly also a remote controller 420 connected via a link 424, which may be preferably implemented as a wireless link using RF or IR communication. Link 424 may be implemented as a one-way link, or preferably a two-way link, which would be very useful for portable and wearable application such as helmet mounted camera system as shown in FIG. 21B and other applications. In such cases, a user while in activity such as doing extreme sports or other activities would be able to remotely control the operation of digital Camera system 10 using a remote control unit 420 and preferably receive indications through the wireless link 424 of the digital Camera system 10 statuses. Camera system 1 may also comprise of a Remote Display Unit 800 which can be connected to a Camera system 10 via a communication link 804 which is preferably a wireless link. Remote Display Unit 800 can be used as an online viewer for watching multimedia data streams such as video of the camera system 10, or as an offline viewer for replay multimedia data. A wireless Remote Display Unit 800 of current invention preferably connected via a wireless link 804 to camera 10 would enable a user to position Camera system 10 at a remote location, such as his helmet and will still enable him to watch video streams of said camera 10 during action activities. A Display Unit 800 may be implemented using LCD or other displays, or using HUD (Head Up Display), or HMD (Head Mounted Display). In addition to video, Remote Display Unit 800 may also display other data types, such as time and date, memory status, location, other sensors data such as velocity and other meta-data. Remote Display Unit 800 may also function as a remote controller of Camera system 10. Yet another alternative of current invention is an additional wireless link with an external wireless network such as WiFi, WiMax, cellular of other wireless links for transferring online and offline video streams from digital Camera system 10 to a remote location and for possible controlling the digital Camera system 10 and for any other data exchange with remote apparatuses.

It would be appreciated by persons skilled in the art that the present invention is not limited by what has been particularly shown and described hereinabove. Rather the scope of the present invention includes both combinations and sub combinations of the various features described hereinabove as well as variations and modifications which would occur to persons skilled in the art upon reading the specification and which are not in the prior art.

1. A camera system comprising of at least:
An image sensor operative to capture images,
A digital processor for processing said images
A storage for storing at least said images,
A light source; and wherein said light source is at least used for creating an illuminating light beam and wherein said illuminating beam may mark at least a point which resides within field of view of said image sensor and wherein said field of view is external to said camera system.

2. A camera system as set forth in claim 1 and wherein apparatus is a digital camera system and wherein said light source utilizes at least one of: a visible light waves, invisible light waves.

3. A camera system as set forth in claim 2 and wherein said light source is laser;

4. A camera system as in claim 3 and wherein said camera system may also consist of built in sensors and wherein said sensors may be at least one of: GPS, accelerometer, tilt, motion, gyro, temperature, humidity, gas, light, sound, electrical sensors.

5. A camera system as in claim 4 and wherein said camera system can capture at least one of the following data formats: video, audio, still pictures, data, any combination of said data formats and wherein said data may be one of: time, date, user information, said sensors' data, any combination of said data.

6. A camera system as set forth in claim 5 and wherein said illuminating light beam has at least one of the following shapes: a dot, plurality of dots, a line, plurality of lines, crossed lines, a frame, a symbol; and wherein said illuminating light beam is aligned with said image sensor optical axis, or is diverted from said image sensor optical axis with a settable, or pre-settable angle.

7. A camera system as set forth in claim 6 and wherein an optical means are used for creating said shapes of said illuminating light beam and wherein said optical means is one of: a diffractive optic element (DOE), or a holographic optical element (HOE) film, hole, mask, lens, or combination of said means;

8. A camera system as set forth in claim 6 and wherein said shapes of illuminating light beam has a size that is related to said camera Field Of View;

9. A camera system as in claim 6 and wherein said shapes of illuminating light beam can change dynamically

10. A camera system as set forth in claim 6 and wherein activation of said illuminating light beam is related to activation and operation of said camera.

11. A camera system as set forth in claim 10 and wherein said illuminating light beam activation is related to the operation of said camera system with at least one of the following activation relationships:
Pressing activation button of said camera system, first activates illuminating light beam then, after a defined time interval illuminating light beam is deactivated and operates camera;
Partial pressing of said camera system activation button, activates said illuminating light beam. A deeper press of camera system activation button deactivates said illuminating light beam and activates the camera system;
Partial pressing of camera system activation button, activates illuminating light beam, where a deeper press of camera system activation button activates the camera system;
Said illuminating light beam is activated by a different button than said camera system activation button. Pressing illuminating light beam activation button activates illuminating light beam, pressing camera activation button activates camera system,
Said illuminating light beam activation is closely synchronized with camera system operation wherein said illuminating light beam is activated while camera system is active and while camera sensor in momentarily inactive, wherein such momentarily blanking periods.

12. A camera system as set forth in claim 6 and wherein said sensors can activate operation said camera.

13. A camera system as set forth in claim 6 and wherein said illuminating light beam is also used for providing indications of said camera system operation, or its status.

14. A camera system as set forth in claim 6 and wherein said camera system is a portable, or a wearable camera

15. A camera system as set forth in claim 14 and wherein said camera system performs video motion stabilization

16. A camera system comprising of at least:
An image sensor operative to capture images,
A digital processor for processing said images
A storage for storing at least said images,
At least one wireless link;
A remote controller
And wherein said camera is capable of capturing and storing at least one of said camera data formats: video, audio, data, and wherein wireless link enables two-way communication between said camera system and said remote controller and wherein said remote controller can remotely control said camera operation and wherein said remote control is capable of providing indications of said camera status and wherein said indications may be one of: visual, audible, mechanical movements, and wherein said camera system can capture at least one of the following data formats: video, audio, still pictures, data, any combination of said data formats.

17. A camera system as set forth in claim 16 and wherein said camera system has also capabilities of camera system as set forth in claim 6

18. A camera system as set forth in claim 16 and wherein said camera system also consists of a portable remote display and wherein said remote display is wirelessly connected to said camera through said wireless link and wherein said remote display is capable of displaying of at least one of said camera data formats.

19. A method for protecting recorded data of a camera system for a later use, wherein said camera system comprising of at least:
An image sensor operative to capture images,
A digital processor for processing said images,
A storage for storing at least said images,
Triggering means;
and wherein said camera system can capture at least one of the following data formats: video, audio, still pictures, data, any combination of said data formats. and wherein said triggering means, may be at least one of the following means: a button, a remote controller, a sensor, processing algorithm of said digital processor, and wherein said camera system, while in operative mode of operation, continuously records said images, onto said memory and where upon activation of said triggering means, images within said memory of X seconds prior to said triggering and Y seconds after said triggering are protected from being erased.

20. A camera system as set forth in claim 6 and wherein said camera also implements method for protecting recorded data as set forth in claim 19.

21 A camera system as set forth in claim 16 and wherein said camera system comprises a laser unit and wherein said laser is used as a data link and wherein said laser unit has at least one of the following functionalities: a laser transmitter for transmitting said camera system data to a remote location, a laser transceiver for transmitting said camera system data to a remote location and receiving remote activation command, and wherein said laser may point said laser light beam to a preset angel;

22. A camera system as set forth in claim 16 and wherein said camera system comprises a laser unit and wherein laser unit said is used as a remote audio sensor and wherein said camera system can record synchronized video, or pictures with audio that is picked up by said laser unit from a remote location.
